(19) United States
(12) Patent Application Publication
(10) Pub. No.: US 2016/0277513 A1
(43) Pub. Date: Sep. 22, 2016

(54) VEHICLE AND METHOD OF SHARING INFORMATION WITH ADJACENT VEHICLES

(71) Applicant: HYUNDAI MOTOR COMPANY, Seoul (KR)

(72) Inventors: Sung Un KIM, Yongin-si (KR); Ki Dong KANG, Seoul (KR); Kyunghyun KANG, Suwon-si (KR); Heejin RO, Seoul (KR); Seok-Young YOUN, Seoul (KR); Bitna BAEK, Seoul (KR); Ga Hee KIM, Suwon-si (KR); Jong Hyuck HEO, Yongin-si (KR); Chisung KIM, Seoul (KR)

(21) Appl. No.: 14/957,564

(22) Filed: Dec. 2, 2015

(30) Foreign Application Priority Data
Mar. 19, 2015 (KR) 10-2015-0038388

(51) Int. Cl. H04L 29/08; H04L 12/24; H04W 12/06; H04B 1/3822; H04W 4/02

(52) U.S. Cl. CPC H04L 67/18; H04B 1/3822; H04W 4/021; H04W 12/06; H04L 67/1044; H04L 41/22; H04W 84/18

(57) ABSTRACT

A vehicle includes a communication unit for forming a local area network with adjacent vehicles, wherein the vehicle is the center and configured to share information with the adjacent vehicles via the vehicle in response to a request of a terminal connected to the vehicle, and a display unit for displaying the shared information.

### CROSS-REFERENCE TO RELATED APPLICATION(S)

This application claims the benefit of priority to Korean Patent Application No. 10-2015-0038388, filed on Mar. 19, 2015 with the Korean Intellectual Property Office, the disclosure of which is incorporated herein by reference.

### TECHNICAL FIELD

Embodiments of the present disclosure relate to a vehicle and a control method thereof, more particularly a vehicle capable of sharing information by forming a local area network with adjacent vehicles, and a control method of the vehicle.

### BACKGROUND

Recently, research has accelerated in developing and commercializing 5^{th} generation mobile communication (5G), and to achieve 5G communications, various research about communication methods, such as wideband frequency method, heterogeneous network method, multi-beam based method, and device to device (D2D) method have been undertaken.

D2D communication method is a communication technology performed directly between devices without transmitting to a network to control increased data traffic. Particularly D2D communication methods allow communication between terminals to be performed without affecting network traffic, so that the effect of increasing total network cell capacity may be expected.

### SUMMARY OF THE DISCLOSURE

Therefore, it is an aspect of the present disclosure to provide a vehicle capable of sharing information by forming a local area network with adjacent vehicles, more particularly, a vehicle capable of sharing information with adjacent vehicles via a vehicle in response to a request of a terminal connected to a vehicle, and a control method of the vehicle.

Additional aspects of the present disclosure will be set forth in part in the description which follows and, in part, will be obvious from the description, or may be learned by practice of the present disclosure.

In accordance with one aspect of the present disclosure, a vehicle includes a communication unit configured to form a local area network with adjacent vehicles as the vehicle is the center and configured to share information with the adjacent vehicles via the vehicle in response to a request of a terminal connected to the vehicle, and a display unit configured to display the shared information.

The communication unit may share information with the adjacent vehicles via the vehicle in response to a request of an application stored in the terminal.

The application may provide an authentication service for the adjacent vehicles, or an adapting service with other application.

The display unit may display a list of the adjacent vehicles or the terminal, both of which are included in a range of the local area network.

The display unit may display of a grouping list, which is a list of grouped adjacent vehicle or grouped terminal, both of which are grouped based on a pre-set reference.

The terminal may be connected to the vehicle through a wired or a wireless communication.

The communication unit may share information with the adjacent vehicles via a server.

The communication unit may share information with the adjacent vehicles via the server when the adjacent vehicle is escaped from the local area network.

The communication unit may form a separate local area network in the vehicle.

The shared information may include at least one common interests of the vehicle and the adjacent vehicle, wherein the at least one common interests is selected from a cluster including education, game, Social Networking Service (SNS), road condition, sights, famous restaurants or destination information.

In accordance with another aspect of the present disclosure, a vehicle includes a communication unit configured to form a local area network with adjacent vehicles via a server and configured to share information with the adjacent vehicles, a display unit configured to display the shared information, and a controller configured to control the communication unit to maintain or block a connection with the adjacent vehicles when the adjacent vehicle is escaped from the local area network.

In accordance with another aspect of the present disclosure, a control method of a vehicle includes forming a local area network with adjacent vehicles as the vehicle is the center, sharing information with the adjacent vehicles via the vehicle in response to a request of a terminal connected to the vehicle, and displaying the shared information.

The sharing information with the adjacent vehicles may include sharing information with the adjacent vehicles via the vehicle in response to a request of an application stored in the terminal.

The sharing information with the adjacent vehicles may include sharing information with the adjacent vehicles via a server.

The sharing information with the adjacent vehicles may include sharing information with the adjacent vehicles via a server when the adjacent vehicle is escaped from the local area network.

The control method may further include forming a separate local area network in the vehicle.

The control method may further include displaying a list of the adjacent vehicles or the terminal, both of which are present in a range of the local area network.

The displaying a list of the adjacent vehicles or the terminal, both of which are present in a range of the local area network may include displaying a list of grouped adjacent vehicle or terminal, both of which are grouped based on a pre-set reference.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a view illustrating an exterior of a vehicle in accordance with one embodiment of the present disclosure;

FIG. 2 is a view illustrating an interior of a vehicle in accordance with one embodiment of the present disclosure;

FIG. 3 is a view illustrating an interior of an autonomous vehicle in accordance with one embodiment of the present disclosure;

FIG. 4 is a view illustrating an interior of an autonomous vehicle in accordance with another embodiment of the present disclosure;

FIG. 5 is a view illustrating an example of a communication between a vehicle and an adjacent vehicle;

FIG. 6 is a view illustrating an example of a communication between a vehicle and an adjacent vehicle when a terminal is involved;

FIG. 7 is a view illustrating an example of a communication between terminals in a vehicle;

FIG. 8 is a view illustrating of an example of a network in which a vehicle is involved in accordance with one embodiment of the present disclosure;

FIG. 9 is a view illustrating of another example of a network in which a vehicle is involved in accordance with one embodiment of the present disclosure;

FIG. 10 is a view illustrating a large scale antenna system of a base station in which a vehicle is involved in accordance with one embodiment of the present disclosure;

FIGS. 11 and 12 are views control block diagrams illustrating a configuration of a host vehicle and an adjacent vehicle;

FIG. 13 is a flowchart illustrating a control method of a vehicle in accordance with one embodiment of the present disclosure;

FIGS. 14A to 16 are views illustrating a process of forming a chat room in accordance with one embodiment of the present disclosure; and

FIG. 17 is a view illustrating an example of forming a chat room in accordance with another embodiment of the present disclosure.

### DETAILED DESCRIPTION

Reference will now be made in detail to embodiments of the present disclosure, examples of which are illustrated in the accompanying drawings.

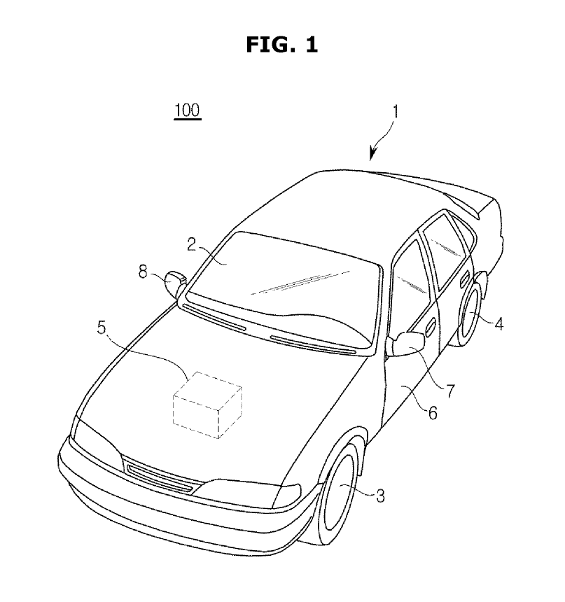

FIG. 1 is a view illustrating an exterior of a vehicle 100 in accordance with one embodiment of the present disclosure.

Referring to FIG. 1, the vehicle 100 may include a body 1 forming an exterior of the vehicle 100, a front glass 2 providing a front view of the vehicle 100 to a driver inside the vehicle 100, vehicle wheels 3 and 4 moving the vehicle 100, a driving device 5 rotating the vehicle wheels 3 and 4, a door 6 closing the inside of the vehicle 100 from the outside, and side mirrors 7 and 8 providing a view of a rear side of the vehicle 100 to the driver.

The front glass 2 may be provided on an upper portion of the front of the vehicle 100 to allow a driver inside the vehicle 100 to acquire visual information about the front of the vehicle 100 and may be referred to as “windshield glass” The vehicle wheels 3 and 4 may include a front wheel 3 provided on a front of the vehicle 100 and a rear wheel 4 provided on a rear of the vehicle 100. The driving device 5 may supply a torque to the front wheel 3 and the rear wheel so that the vehicle 100 may be moved forward or backward. The driving device 5 may employ an engine configured to generate a torque by burning fossil fuel or a motor configured to generate a torque by receiving power source from a capacitor (not shown) or a battery.

The door 6 may be rotatably provided on a right side and a left side of the body 1. When the door 6 is opened, a driver may be allowed to be seated in the vehicle 100, and when the door 6 is closed, the inside of the vehicle 100 may be closed from the outside. A window may be installed in the door 6 to see the outside or to see the inside of the vehicle 100 from the outside. According to embodiments, a window may be installed to see from only one side, and may be installed to be openable/closable.

The side mirrors 7 and 8 may include a left side mirror 7 provided on the left side of the body 1 and a right side mirror 8 provided on the right side of the body 1. The side mirrors 7 and 8 may allow a driver inside the vehicle 100 to acquire visual information of the lateral side and the rear side of the vehicle 100.

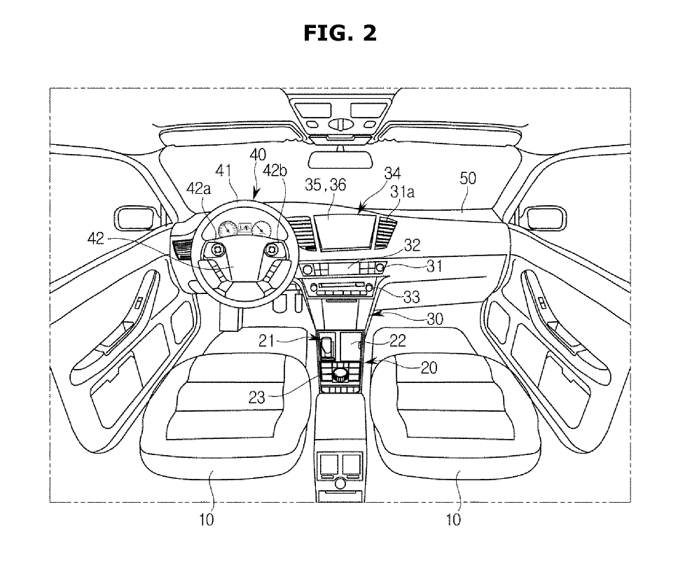

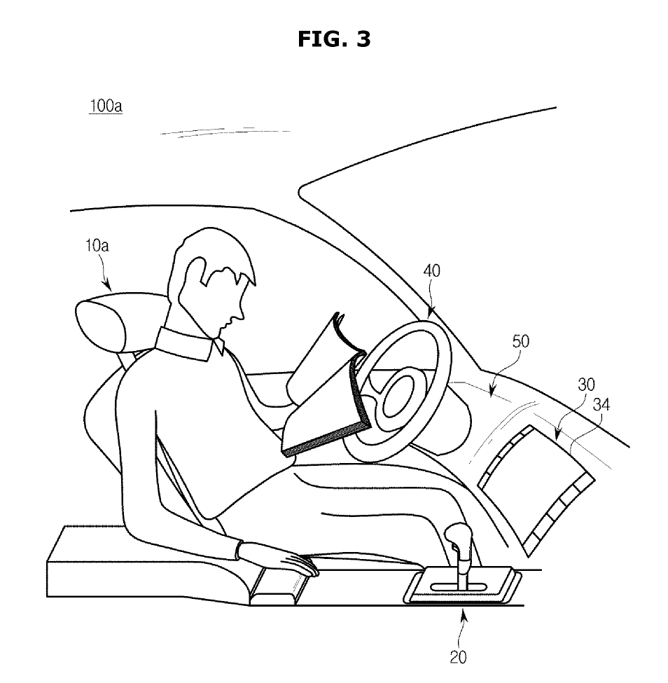

FIG. 2 is a view illustrating an inner configuration of a vehicle 100 in accordance with one embodiment of the present disclosure. Referring to FIG. 2, the vehicle 100 may include a seat 10 in which a driver or a passenger is seated, and a dashboard 50 in which a gear box 20, a center fascia 30, and a steering wheel 40 are provided.

In the gear box 20, a gear lever 21 configured to change a speed of the vehicle 100, and a touch pad 22 configured to control an operation of functions of the vehicle 100 may be installed. Meanwhile, as needed, a dial operation unit 23 may be selectively installed in the gear box 20.

An air conditioning device 31, a clock 32, an audio device 33 and an audio video navigation (AVN) device 34 may be installed in the center fascia 30.

The air conditioning device 31 may keep an air inside the vehicle 100 fresh by controlling a temperature, a moisture, an air quality, and a flow of air of the inside of the vehicle 100. The air conditioning device 31 may be installed in the center fascia 30 and may include at least one discharging port 31a for discharging air. A button or a dial may be installed in the center fascia 30 to control the air conditioning device 31. A user, such as a driver, may control the air conditioning device 31 by using a button disposed on the center fascia 30.

The clock 32 may be provided adjacent to a button or a dial which are configured to control the air conditioning device 31.

The audio device 33 may include an operation panel in which a number of buttons are provided to perform functions of the audio device 33. The audio device 33 may provide a radio mode configured to provide a radio function, and a media mode configured to play an audio file of various storage media in which the audio file is stored.

The AVN device 34 may be embedded inside the center fascia 30 of the vehicle 100. The AVN device 34 may be a device configured to integrally operate an audio function, a video function, and a navigation function according to an operation by a user. The AVN device 34 may include an input unit 35 configured to receive an input of a command about the AVN device 34 from a user, and a display unit 36 configured to display a screen related to an audio function, a screen related to a video function, and a screen related to a navigation function.

The steering wheel 40 may be a device configured to adjust a driving direction of the vehicle 100, and may include a rim 41 held by the driver and a spoke 42 connected to a steering system of the vehicle 100 and configured to connect the rim 41 to a hub of a rotation shaft for the steering. According to embodiments, manipulation devices 42a and 42b may be formed in the spoke 42 to control various devices inside the vehicle 100, such as an audio device.

According to embodiments, the dashboard 50 may further include various gauge boards indicating a driving speed of the vehicle 100, and the number of engine rotations or a fuel status, and a globe box in which various things can be stored.

The vehicle 100 in accordance with embodiments may include an autonomous vehicle besides the aforementioned vehicle 100. Particularly, the autonomous vehicle is a vehicle capable of sensing its environment when driving, self-determining a driving path, and driving independently by using power of the vehicle. Hereinafter the autonomous vehicle may be described with reference to drawings.

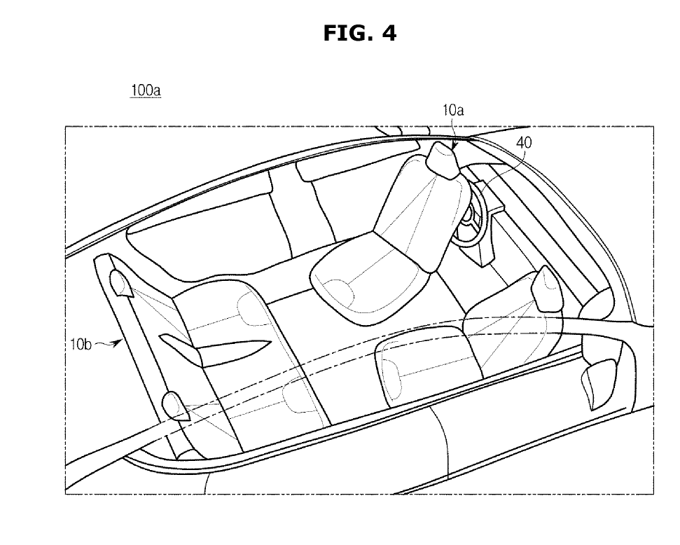

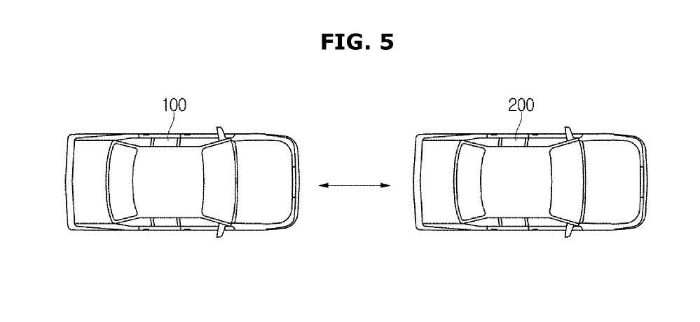

FIG. 3 is a view illustrating an interior of an autonomous vehicle 100a in accordance with one embodiment of the present disclosure, and FIG. 4 is a view illustrating an interior of an autonomous vehicle 100a in accordance with another embodiment of the present disclosure. The autonomous vehicle 100a as illustrated in FIGS. 3 and 4 may include components that are the same as illustrated in FIG. 1, but according to embodiments the autonomous vehicle 100a may not include the gear box 20 and the steering wheel 40.

Referring to FIGS. 3 and 4, the autonomous vehicle 100a in accordance with one embodiment may perform self-driving regardless of if a driver reads a newspaper in the vehicle or a driver falls asleep. A driver seat 10a may be disposed to face to the forward of the vehicle, as illustrated in FIG. 3 or alternatively may be disposed to face to a rear passenger seat 10b, as illustrated in FIG. 4.

In the autonomous vehicle 100a, a software technique, which is configured to perform quick and accurate decision-making related to driving of the vehicle by analyzing data collected via a sensor, may be applied. Particularly, various sensing techniques, mapping techniques, recognition/determination techniques, and communication techniques may be applied to the autonomous vehicle 100a.

The sensing technique is configured to sense environments, and according to embodiments, devices, such as multi-video camera, forward looking infrared sensor, radar, GPS, lidar, and gyroscopes may be applied to the sensing technique. The mapping technique is configured to estimate an absolute/a relative position of the vehicle, and a distance, a departure, a destination, and a road condition may be displayed by a coordinate with spot and line. The recognition/determination technique is configured to plan a path to a destination, and to plan a path to avoid an obstacle. Particularly, the recognition/determination technique may combine data acquired via aforementioned sensors, compare the combined data with stored mapping data, and then determine how to response to other vehicles, a traffic control device, and a pedestrian and an obstacle. Meanwhile, the D2D communication method may be applied as the communication and control technique, a description thereof will be described in a related part.

Hereinafter, for description convenience, the vehicle 100 as illustrated in FIG. 1, among aforementioned vehicles 100 and 100a will be described as an example.

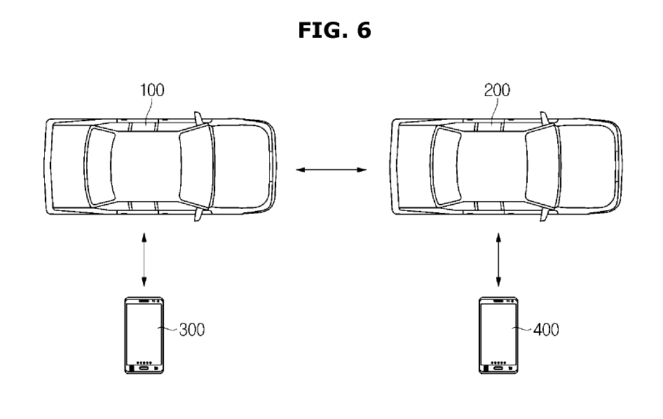

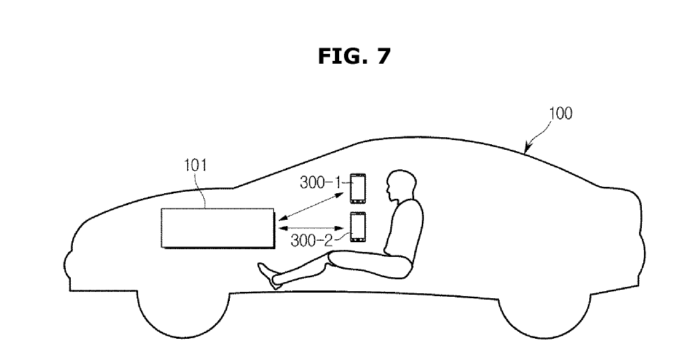

FIG. 5 is a view illustrating an example of a communication between a vehicle 100 and an adjacent vehicle 200, FIG. 6 is a view illustrating an example of a communication between a vehicle 100 and an adjacent vehicle 200 when a terminal 300 and 400 is involved, and FIG. 7 is a view illustrating an example of a communication between terminals 300-1, and 300-2 in a vehicle 100.

Referring to FIG. 5, the vehicle 100 in accordance with one embodiment may perform a communication with an adjacent vehicle 200 driving in a place adjacent to the vehicle 100 by using a D2D communication method, or by using a communication technique via a base station according to embodiments. D2D communication methods and the communication technique via a base station may be independently performed or combinedly performed, and when both communication techniques are combinedly performed, the communication may be performed in a way that the communication technique via a base station may complement D2D communication method.

According to one embodiment, when a plurality of vehicles 100 and 200 is present on a road, a local area network may be formed with each vehicle as the center. Particularly, a single vehicle 100 among the plurality of vehicles may form a local network with an adjacent vehicle 200, and the vehicle 100 may share information with the adjacent vehicle 200 via the formed network. Hereinafter, a network formed with a certain vehicle 100 as the center in a range where a radio wave of the vehicle 100 reaches, may be referred to as a local area network, and a vehicle which is the host of a local area network, may be referred to as the host vehicle 100.

The adjacent vehicle 200 may be under the same condition as the host vehicle 100, particularly, the adjacent vehicle 200 may be a vehicle stagnant on the same road with the host vehicle 100, or may be a vehicle driving toward the same destination as that of the host vehicle 100. According to embodiments, the adjacent vehicle 200 may include a vehicle driving in an opposite direction to the host vehicle 100. Referring to FIG. 6, the host vehicle 100 and the adjacent vehicle 200 may perform a communication with the terminals 300 and 400 carried by a passenger of each vehicle, via a wired or wireless communication. Hereinafter, a terminal carried by a passenger of the host vehicle 100 may be referred to as a first terminal 300, and a terminal carried by a passenger of the adjacent vehicle 200 may be referred to as a second terminal 400. The first terminal 300 and the second terminal 400 may be provided in plural, hereinafter for description convenience, it may be assumed that a single first terminal 300 and a single second terminal 400 are provided.

The host vehicle 100 and the first terminal 300 may perform a communication by using a communication technique, such as 3Generation (3G), 4Generation (4G), Wireless LAN, Wi-Fi, Bluetooth, Zigbee, Wi-Fi Direct (WFD), Ultra wideband (UWB), IrDA; Infrared Data Association, Bluetooth Low Energy (BLE), and Near Field Communication (NFC). In addition, the adjacent vehicle 200 and the second terminal 400 may perform a communication by using the same communication technique as that of the host vehicle 100 and the first terminal.

A passenger of the host vehicle 100 may form a local area network with the host vehicle 100 as the center by accessing an application installed on the first terminal 300. In other words, the application installed on the first terminal 300 may provide an authentication service to the adjacent vehicle 200. Meanwhile, when a local network is formed between the host vehicle 100 and the adjacent vehicle 200 with the host vehicle 100 as the center, the first terminal 300 connected to the host vehicle 100 and the second terminal 400 connected to adjacent vehicle 200 may be automatically connected each other. In other words, the connection of the host vehicle 100 and the adjacent vehicle 200 may play a function as the authentication of the connection of the first terminal 300 and the second terminal 400.

When a local area network is formed, the host vehicle 100 may share data with the adjacent vehicle 200, and the shared data may be displayed via a display unit of the first terminal 300. According to embodiments, a screen displayed on the display unit of the first terminal 300 may be displayed on the display unit 35 of the AVN device 34 by using a mirroring technique. Meanwhile, in a process of sharing information between the host vehicle 100 and the adjacent vehicle 200, the application installed in the first terminal 300 may serve an adapting service with another application, and related description will be described later.

Referring to FIG. 7, a separate local area network may be formed in the vehicle 100. Herein, the vehicle 100 may include any kind of vehicle 100 in which a communication modem 101 configured to form a network is provided.

The vehicle 100 according to embodiments may support a communication in the vehicle 100 through the communication modem 101 in the vehicle 100. The communication in the vehicle 100 may include a communication between terminals 300-1 and 300-2 both of which are carried by passengers in the vehicle 100, or a communication between each terminal 300-1 and 300-2 and a vehicle. According to embodiments, a certain terminal 300-1 in the vehicle may become a host, and may form a separate local area network in the vehicle.

In a communication process between the host vehicle 100 and the adjacent vehicle 200, when the host vehicle 100 and the adjacent vehicle 200 stop on a road, a range of local area network, which is formed with the host vehicle 100 as the center, may be maintained. When the host vehicle 100 and the adjacent vehicle 200 drive on a road, the range of the local area network, which is formed with the host vehicle 100 as the center may be changed. In other words, another vehicle included in a range of local area network, which is formed with the host vehicle 100 as the center, may become outside from the range of the local area network as time passes, and another vehicle, which is excluded from a range of local area network of the host vehicle 100, may become included in the range of the local area network of the host vehicle 100.

Therefore, for description convenience, a setting method of local area network of the host vehicle 100, relating to FIGS. 5 and 6, will be described in detail prior to describing the present disclosure in detail.

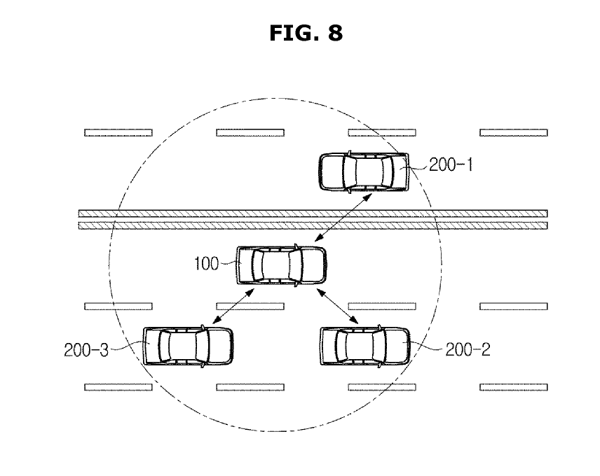

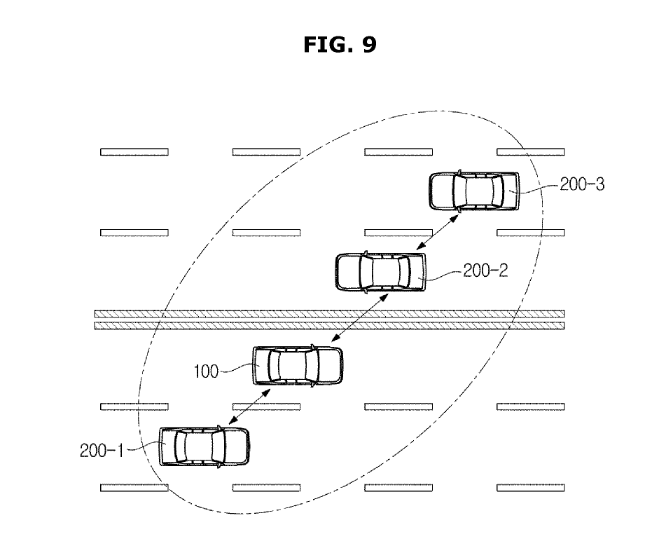

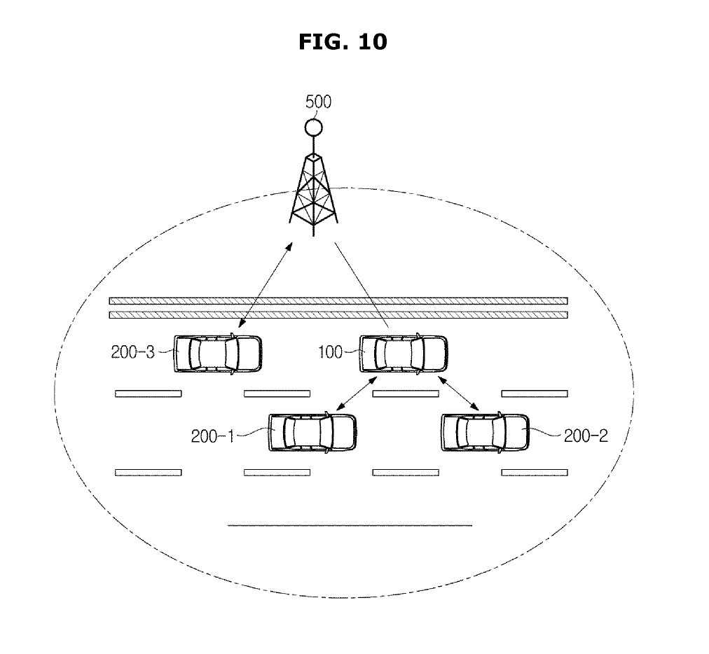

FIG. 8 is a view illustrating an example of a network in which a vehicle 100 is involved in accordance with one embodiment of the present disclosure, FIG. 9 is a view illustrating another example of a network in which a vehicle 100 is involved in accordance with one embodiment of the present disclosure, and FIG. 10 is a view illustrating a large scale antenna system of a base station 500 in which a vehicle 100 is involved in accordance with one embodiment of the present disclosure.

Referring to FIGS. 8 and 9, the host vehicle 100 may form a local area network with adjacent vehicles 200-1, 200-2, and 200-3 present in a range where a radio wave reaches. According to embodiments, the host vehicle 100 may form each group, which are different from each other and included in the same local area network, through software, such as an application. The host vehicle 100 may form a local area network and then may maintain the local area network. But the host vehicle 100 may also remove the local area network in the middle as needed.

The host vehicle 100 may share information with the adjacent vehicle 200 present in the range of the local area network by using a D2D communication method. A D2D communication method is a communication performed between devices, and represents a communication configured to transmit and receive a radio signal including various data stored in a device as well as data detected via a sensor. A D2D communication method may be a support method for Proximity Service (ProSe), and may support an operation to discover an application operated in adjacent devices and to exchange data related to the application. In other words, by setting a direct link between a plurality of devices, a device may directly transmit/receive related data to/from another device without passing an additional network.

The host vehicle 100 may perform D2D communication method with adjacent vehicles 200-1, 200-2, and 200-3 via 5G (5^{th} generation mobile networks). 5G is a communication method using approximately 28 GHz of frequency band, and in 5G, large scale antenna system may be employed. The large scale antenna system may allow ultra-high frequency band to be covered up by using several tens or more antennas and may allow large amounts of data to be transmitted and received simultaneously via a plurality of connections. Particularly, the large scale antenna system may allow radio waves to be transmitted and received further in a certain direction by adjusting the array of antenna elements and thus an available area of 5G network may be expended as well as large amounts of data may be transmitted.

5G may allow more adjacent vehicles 200-1, 200-2, and 200-3 to access and to transmit/receive large capacity data simultaneously by transmitting a radio signal, which is modulated in Non-Orthogonal Multiplexing Access (NOMA) modulation method. Accordingly, the host vehicle 100 may allow the plurality of adjacent vehicles 200-1, 200-2, and 200-3 to access the host vehicle 100 and may share information with the plurality of adjacent vehicles 200-1, 200-2, and 200-3. Meanwhile, the host vehicle 100 may keep transmitting/receiving data to/from the adjacent vehicles 200-1, 200-2, and 200-3 as far as a radio wave can reach the adjacent vehicles 200-1, 200-2, and 200-3. Since 5G radio waves have a directivity, when the location of the host vehicle 100 or the location of the adjacent vehicles 200-1, 200-2, and 200-3 are changed, the host vehicle 100 may share information with the adjacent vehicles 200-1, 200-2, and 200-3 as 5G radio waves generated in the host vehicle 100 track the adjacent vehicles 200-1, 200-2, and 200-3.

Meanwhile, depending on a situation, any one adjacent vehicle of the adjacent vehicles 200-1, 200-2, and 200-3, which perform D2D communication with the host vehicle 100 in a range of local area network formed by the host vehicle 100, may escape from the local area network. In this case, when the adjacent vehicle 200-1, 200-2, and 200-3, which has escaped from the network, is intended to keep sharing information with the host vehicle 100, information may be shared via the base station 500.

Referring to FIG. 10, the base station 500 may simultaneously transmit/receive data to/from the plurality of the adjacent vehicles 200-1, 200-2, and 200-3 via large scale antenna system. The large scale antenna system may minimize a radio wave discharged in a direction other than a direction of transmitting a radio wave, thereby reducing a noise. Accordingly, the enhancement of transmission quality and the reduction of the amount of power may be achieved at the same time. But the formation of 5G network is not limited thereto, and a 5G network may be formed in multihop method.

In FIGS. 8 to 10, a case in which D2D communication between the host vehicle 100 and the adjacent vehicles 200-1, 200-2, and 200-3 may be performed as the host vehicle 100 becomes the center, and a communication via the base station 500 may be subsidiarily performed, is illustrated as an example, but is not limited thereto. For example, a plurality of vehicles 100, 200-1, 200-2, and 200-3 may form a local area network with the base station as the center, and may perform a communication with the base station as the center. In this case, when a certain vehicle is escaped from the range of the local area network, the connection of the network of the vehicle, which has escaped from the range of the local area network, may be maintained or blocked through a server of the base station 500.

Hereinbefore embodiments are schematically described. Hereinafter a configuration of the vehicle 100 in accordance with one embodiment will be described in detail.

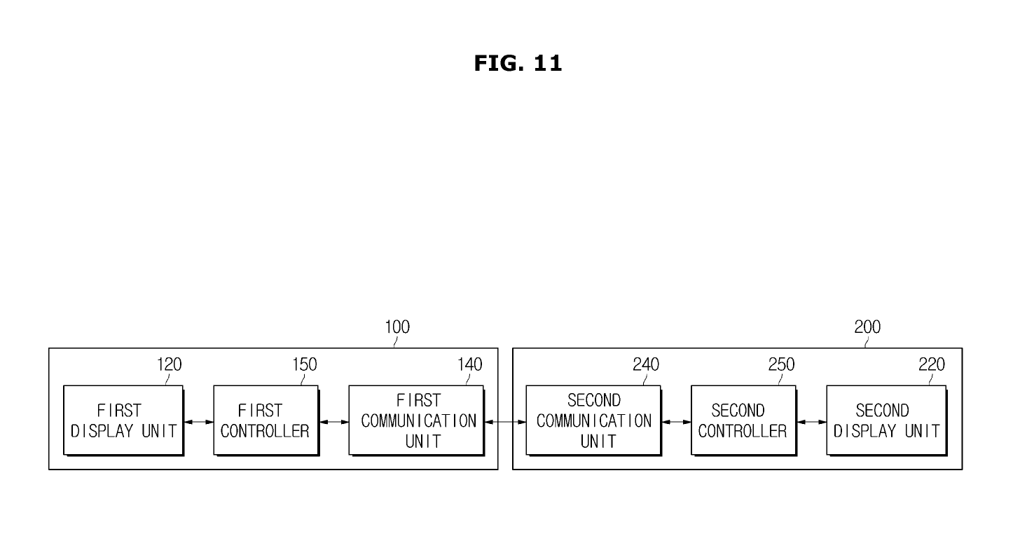

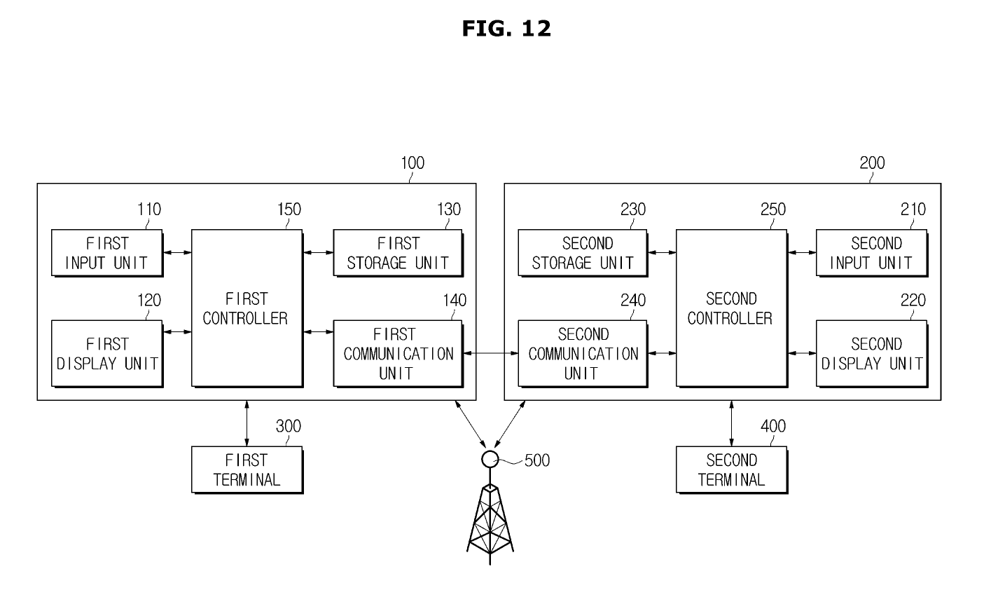

FIGS. 11 and 12 are views of control block diagrams illustrating a configuration of a host vehicle 100 and an adjacent vehicle 200.

Referring to FIGS. 11 and 12, the host vehicle 100 may include an input unit 110, a display unit 120, a storage unit 130, a communication unit 140, and a controller 150. The adjacent vehicle 200 may include an input unit 210, a display unit 220, a storage unit 230, a communication unit 240, and a controller 250.

Hereinafter in order to avoid confusion of the configuration of the host vehicle 100 and the configuration of the adjacent vehicle 200, the input unit 110, the display unit 120, the storage unit 130, the communication unit 140, and the controller 150 of the host vehicle 100 may be referred to as a first input unit 110, a first display unit 120, a first storage unit 130, a first communication unit 140, and a first controller 150, respectively. In addition, the input unit 210, the display unit 220, the storage unit 230, the communication unit 240, and the controller 250 of the adjacent vehicle 200 may be referred to as a second input unit 210, a second display unit 220, a second storage unit 230, a second communication unit 240, and a second controller 250, respectively. Meanwhile, when a plurality of vehicles is present on a road, a main configuration of the adjacent vehicle 200 may be practically the same as that of the host vehicle 100 since any vehicle may play a role as the host vehicle. Therefore, hereinafter a description of the configuration of the host vehicle 100 may include a description of the configuration of the adjacent vehicle 200.

The first input unit 110 may receive an input of a control signal, which is related to various functions of the vehicle 100, from a user, and the first input unit 110 may transmit the input control signal to the first controller 150. The first input unit 110 may be a concept including the input unit 35 of the AVN device 34, and may be implemented by a push button device or a touch panel.

The first input unit 110 may receive an input of a control signal configured to collect location information of the adjacent vehicle 200 placed around the host vehicle 100, or location information of the second terminal 400, and the first input unit 110 may transmit the input control signal to the first controller 150. According to embodiments, the first input unit 110 may receive an input of radius information, which is to discover the adjacent vehicle 200 placed around the host vehicle 100, or the second terminal 400, from a user.

The first display unit 120 may employ Light Emitting Diode (LED) or Liquid Crystal Display (LCD), but is not limited thereto. Meanwhile, the first display unit 120 may be a concept including the display unit 36 of the AVN device 34. The first display unit 120 may be integrally formed with the first input unit 110, or may be separately formed from the first input unit 110.

The first display unit 120 may display information related to the adjacent vehicle 200 or the second terminal 400, particularly information related to the adjacent vehicle 200 or the second terminal 400, both of which are present in the local area network of the host vehicle 100. Meanwhile, when the local area network is reset while the host vehicle 100 drives, the first display unit 120 may display information related to the adjacent vehicle 200 or the second terminal 400, both of which are present in the reset local area network. In addition, the first display unit 120 may display information related to the adjacent vehicle 200 or the second terminal 400, both of which are newly involved in the local area network, and may not display information related to the adjacent vehicle 200 or the second terminal 400, both of which are escaped from the local area network.

The information related to the adjacent vehicle 200 or the second terminal 400 may include identification information related to the adjacent vehicle 200 or the second terminal 400. The identification of the adjacent vehicle 200 may include a vehicle number of the adjacent vehicle 200, and the identification of the second terminal 400 may be a phone number of the second terminal 400. According to embodiments, the identification information of the adjacent vehicle 200 or the second terminal 400 may include nickname information of the adjacent vehicle 200 or the second terminal 400, wherein the nickname information may include a nickname, which is pre-set by a user of the adjacent vehicle 200 or the second terminal 400, or a nickname, which is pre-set based on a manufacturer, device type, or device color.

The first display unit 120 may display the identification information of the adjacent vehicle 200 and the second terminal 400 in a list type. In this case, the identification list may be an identification list, which is extracted based on a pre-set reference. For example, the first display unit 120 may display a list of the adjacent vehicle 200 or the second terminal 400, which have the same destination, among a plurality of vehicles present in the local area network of the host vehicle 100. In this case, the destination information may be information collected by using destination information inputted into a navigation system, and the adjacent vehicle 200 and the second terminal 400 may be displayed together in a grouped manner, or in a separate manner.

The first display unit 120 may display a grouping list, which is a list of grouped adjacent vehicles 200 based on a pre-set reference. For example, the adjacent vehicle 200 may be grouped based on a certain reference, such as the vehicle type, the vehicle color, and the manufacturer of vehicle, besides the destination of the adjacent vehicle 200, and the first display unit 120 may display the grouping list. In this case, a user may select a reference for grouping, and may allow vehicles fitting the selected reference among the adjacent vehicles 200, to be displayed on the first display unit 120, or when selecting a grouping list according to a user environment setting, vehicles included in a corresponding grouping list may be automatically grouped.

The first display unit 120 may display a chat room formed by a grouped vehicle, and may display a list of chat rooms when a number of chat rooms are formed. Particularly, a user of the host vehicle 100 may generate a chat room to share common interests with the adjacent vehicles 200 included in a range of local area network. Herein, the adjacent vehicles 200 may be the grouped adjacent vehicles 200 according to aforementioned method. In this case, on the second display unit 220 of the adjacent vehicle 200, a message window indicating an invitation to a chat room, and when a user of the adjacent vehicle 200 accepts the invitation, the user of the adjacent vehicle 200 may be invited to the chat room and share common interests with a user of the host vehicle 100. According to embodiments, on the second display unit 220 of the adjacent vehicle 200, a list of generated chat rooms may be displayed, and a user of the adjacent vehicle 200 may directly enter the generated chat room according to the selection by the user of the adjacent vehicle 200.

The first display unit 120 may display shared information, which is shared with the adjacent vehicle 200. According to embodiments, the shared information may include common interests of the host vehicle 100 and the adjacent vehicle 200, more particularly, education, game, Social Networking Service (SNS), road condition, sights, restaurant or destination information.

At least one terminal 300 and 400 may be connected to the host vehicle 100 or the adjacent vehicle 200 via a wired or wireless communication. According to one embodiment, when a single first terminal 300 is connected to the host vehicle 100, a screen of the first terminal 300 may be displayed on the first display unit 120 of the host vehicle 100 in a mirroring manner. Meanwhile, when a plurality of terminals is connected to the host vehicle 100, a screen of a single terminal among the plurality of terminals may be displayed on the first display unit 120 of the host vehicle 100 in a mirroring manner. For example, when a person among passengers of the host vehicle 100 generates a game room and the person becomes a leader of the game group, a screen of a leader's terminal may be displayed on the first display unit 120 of the host vehicle 100 in a mirroring manner. In this case, another passenger of the host vehicle 100 may share a screen displayed on the terminal of the leader via a screen displayed on the first display unit 120.

The first storage unit 130 may store various data and programs or applications for driving and controlling the vehicle 100. Particularly, the first storage unit 130 may store programs, such as a control program for controlling the vehicle 100, an application initially provided from a manufacturer or a general purpose application downloaded from the outside. Moreover, the first storage unit 130 may store information related to the adjacent vehicle 200 performing D2D communication with the vehicle 100, information related a chat room generated by the vehicle 100, and information related to access to the adjacent vehicle 200. In addition, the storage unit 130 may store shared information collected from the adjacent vehicle 200, and may perform a function to temporarily store an input/out signal.

The first storage unit 130 may include at least one of a storage unit medium among flash memory, hard disc, memory card, Read-Only Memory (ROM), Random Access Memory (RAM), Electrically Erasable Programmable Read-Only Memory (EEPROM), Programmable Read-Only Memory (PROM), magnetic memory, magnetic disk, and optical disk.

The first communication unit 140 may form a local area network between the host vehicle 100 and the adjacent vehicles 200 as the host vehicle 100 is the center, and may share information with the adjacent vehicles 200 via D2D communication. The first communication unit 140 may share information with the adjacent vehicles 200 as the host vehicle 100 becomes a medium, in response to a request of the first terminal 300. The process in series may be performed in response to a request of an application stored in the first terminal 300.

The first communication unit 140 may share information with the adjacent vehicle 200 via 5G communication method. The communication method of the first communication unit 140 is not limited to a 5G communication method, and may use 3Generation (3G), 4Generation (4G), Wireless LAN, Wi-Fi, Bluetooth, Zigbee, Wi-Fi Direct (WFD), Ultra wideband (UWB), Infrared Data Association (IrDA), Bluetooth Low Energy (BLE), or Near Field Communication (NFC). However, for description convenience, it may be assumed that D2D communication is performed by using 5G communication method.

Since a 5G communication method is capable of transmitting data at a transfer rate of up to 1 Gbps, 5G communication method may support an immersive communication, which needs large capacity transmission, such as Ultra-HD (UHD), 3D, and hologram, through large capacity transmission. Accordingly, the vehicle 100 and the adjacent vehicle 200 may share a variety of information, regardless of the type of information. In addition, a 5G communication method is capable of performing real-time processing with the maximum response time 1 ms or less and thus 5G communication method is capable of supporting a real-time service which reacts before a user recognizes

Through providing large capacity and super-real-time processing, the vehicle 100 may provide big data services to passengers in the vehicle 100. For example, the vehicle 100 may provide customized information, which is appropriate for a condition of a passenger in the vehicle 100, by analyzing a variety of education information, game information, and SNS information, which are shared with the adjacent vehicle 200. According to one embodiment, the vehicle 100 may collect road condition, sights, restaurant, and attractive information, which are around a driving path, through big data mining, and then may provide the information in real-time.

The first communication unit 140 may share information with the adjacent vehicle 200 via the base station 500. The first communication unit 140 may share information with the adjacent vehicle 200 by combining a D2D communication method and a communication method configured to pass the base station 500, or by using a communication method configured to initially pass the base station 500. Hereinafter a description of the same parts as those shown in FIG. 5, related to sharing information via the base station 500, will be omitted.

The first controller 150 may control an overall operation of the vehicle 100 and a signal flow between internal components of the vehicle 100, and may process data. The first controller 150 may execute an Operation System (OS), and various applications stored in the first storage unit 130 when a user inputs or a pre-set condition is satisfied.

The first controller 150 may include a networking unit. The networking unit may support to form a local area network with the host vehicle 100 as the center, as needed, and particularly, may support a local area network with the host vehicle 100 as the center in a range where a radio wave of the host vehicle 100 can reach. At this time, in the range where the radio wave of the host vehicle 100 reaches, a single local area network may be formed, or groups different from each other may be formed in the same local area network by using a program, such as an application.

The networking unit may maintain the local area network, which is formed by aforementioned method, may remove the local area network in the middle, or may reset the local area network. The networking unit may include a vehicle modem, and a user may form a local area network by directly manipulating a vehicle modem terminal or by accessing the vehicle modem terminal via the first terminal 300.

The first controller 150 may control so that an identification of the adjacent vehicle 200 or the second terminal 400 present in the range of the local area network of the host vehicle 100 is displayed on the first display unit 120. According to embodiments, the first controller 150 may control so that a screen of the first display unit 120 is displayed on a display unit of the first terminal 300 in a mirroring manner.

The first controller 150 may group the adjacent vehicle 200 or the second terminal 400 based on a certain reference, and may control so that a result of grouping is displayed on the first display unit 120. For example, the first controller 150 may group vehicles having the same destination among a number of vehicles present in the local area network of the host vehicle 100, and may control so that an identification of the grouped adjacent vehicle 200 is displayed on the first display unit 120. Herein, destination information may be navigation destination information collected from the adjacent vehicle 200. Meanwhile, the first controller 150 may control so that a grouping reference is displayed on the first display unit 120, hereinafter a description the same as those described above will be omitted.

The first controller 150 may form a chat room by inviting the adjacent vehicle 200 or the second terminal 400 present in the range of the local area network according to a command from a user.

The user may form a chat room by directly selecting an identification of the adjacent vehicle 200 or the second terminal 400 existing in the range of the local area network. In this case, a chat widow indicating an invitation to a chat room may be formed on the second display unit 220 of the adjacent vehicle 200 or a display unit of the second terminal 400. In addition, the user may form a chat room in advance so that the adjacent vehicle 200 or the second terminal 400 both with access to the local area network are allowed to directly participate in the chat room. In this case, a chat window indicating a request of access to a chat window may be formed on the host vehicle 100. The method of forming a chat room is not limited thereto, and the user may generate a chat room by selecting a list of the adjacent vehicle 200 which share a destination with the host vehicle 100.

The chat room may be formed in various types, such as a peer room, and game room, according to a purpose of an application. A user may participate to each chat room according to the purpose, and according to embodiments, the same user may simultaneously access a plurality of chat rooms.

The first controller 150 may share information with the adjacent vehicle 200. Particularly, the first controller 150 may share information with the adjacent vehicle 200 via a vehicle in response to a request of the host vehicle 100, may share information with the adjacent vehicle 200 via the host vehicle 100 in response to a request of the first terminal 300, may share information with the adjacent vehicle 200 via a server of the base station 500, or may share information with the adjacent vehicle by using a method, which is a combination of aforementioned methods. According to embodiments, shared information may include common interests of the host vehicle 100 and the adjacent vehicle 200, and particularly may include educational information, game information, SNS information, road conditions, sights, restaurants, and destination information.

The first controller 150 may form a separate local area network inside the vehicle in response to a command from a user. When a plurality of passengers boards the vehicle 100 with terminals, the terminals carried by the passengers may share information by using D2D communication method via the separate local area network formed in the vehicle, and hereinafter a description the same as those described above will be omitted.

Hereinbefore D2D communication between the vehicle 100 and the adjacent vehicle 200 is described in accordance with one embodiment. In general, any kind of vehicle, which is on a road, capable of performing D2D communication, may become the host vehicle 100 and thus aforementioned embodiments may include a case in which the host vehicle 100 in a certain chat room, accesses another chat room as the adjacent vehicle 200.

Next, a control method of a vehicle according to one embodiment will be described.

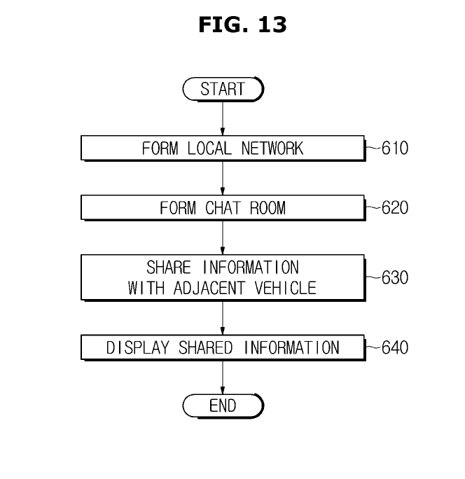

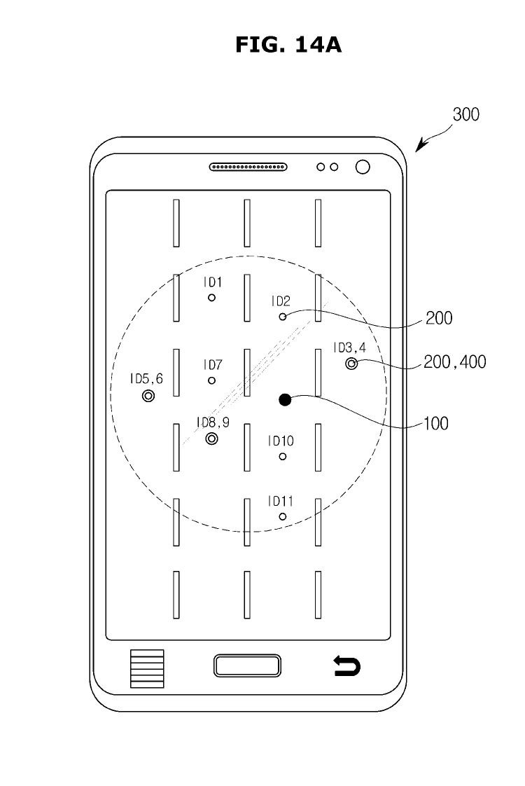

FIG. 13 is a flowchart illustrating a control method of a vehicle in accordance with one embodiment of the present disclosure.

As illustrated in FIG. 13, a control method of a vehicle according to one embodiment may include forming a local area network 610, generating a chat room based on the formed local area network 620, sharing information with adjacent vehicles 630, and displaying shared information 640.

At first, a local area network may be formed with a certain vehicle as the center in a range where a radio wave of a vehicle reaches 610. Any kind of vehicle present on a road may become a host vehicle, and thus a range of local area network may be differently formed depending on which vehicle becomes a host vehicle.

Next, an operation of grouping adjacent vehicles included in the range of the local area network may be performed. According to embodiments, when a user performs grouping adjacent vehicles based on a certain reference, the operation of grouping adjacent vehicles may be performed, but the operation of grouping may be omitted in some cases.

Next, an operation of generating a chat room based on the local area network may be performed 620. An operation of generating a chat room may be performed in a way of inviting the adjacent vehicle 200 or the second terminal 400 both of which are present in the range of the local area network, and in a way that the adjacent vehicle 200 or the second terminal 400 joins to the generated chat room. According to embodiments, a chat room may be formed in a way of selecting a list of the adjacent vehicle 200, which share a destination with the host vehicle 100.

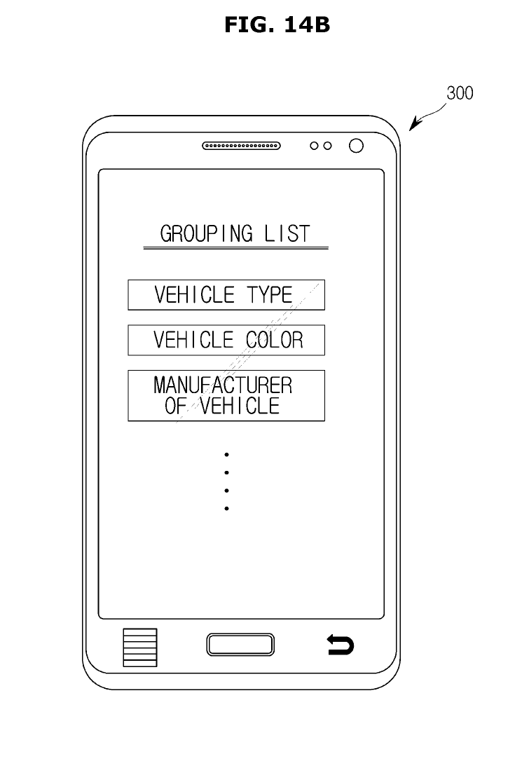

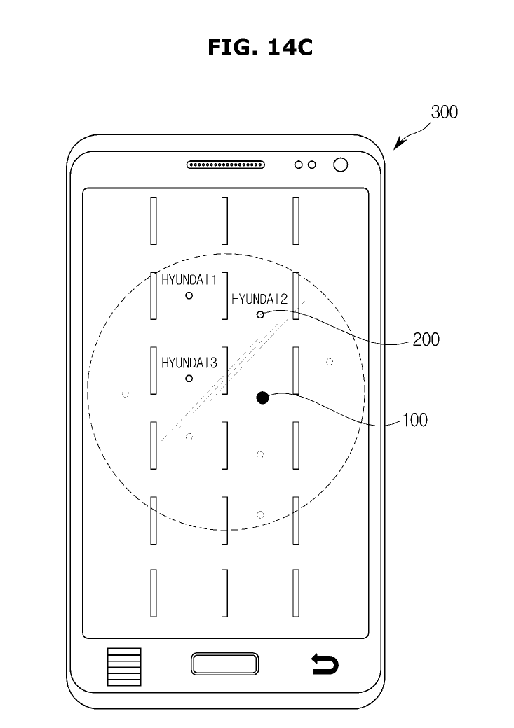

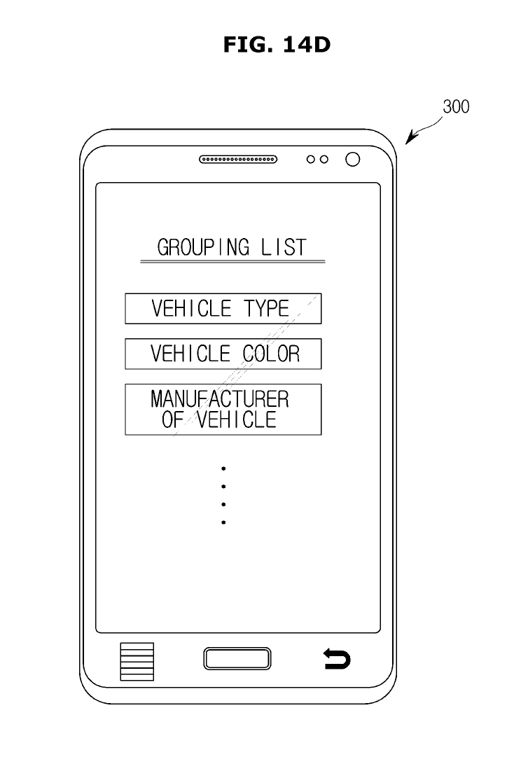

FIGS. 14 to 16 are views illustrating a process of forming a chat room in accordance with one embodiment of the present disclosure. As illustrated in FIGS. 14 to 16, a screen to form a chat room may be displayed on a display unit of the first terminal 300 connected to the host vehicle 100, and a screen of the display unit of the first terminal 300 may be simultaneously displayed on the first display unit 120 of the host vehicle 100 in a mirroring manner. Hereinafter a method of forming a chat room will be described with a display unit of the first terminal 300 as an example.

FIGS. 14A to 14D are views illustrating an example of the adjacent vehicle 200 included in a range of local area network of the host vehicle 100.

FIG. 14A is a view illustrating a screen displaying an identification of the adjacent vehicle 200 or the second terminal 400 included in the range of the local area network. Referring to FIG. 14A, on the display unit of the first terminal 300, a range of a local area network formed with the host vehicle 100 as the center may be displayed, a location of the adjacent vehicle 200 or the second terminal 400 included in the range of the local area network may be displayed, and identification information of the adjacent vehicle 200 or the second terminal 400 may be displayed. Herein, the location of the host vehicle 100, the range of the local area network formed with the host vehicle 100 as the center, the location of the adjacent vehicle 200 included in the range of the local area network may be changed as time passes, and the display unit of the first terminal 300 may display the location of the host vehicle 100 and the location of the adjacent vehicle 200, both of which are changed as time passes, in real-time.

According to embodiments, an identification of the vehicle 200 and an identification of the second terminal 400 may be simultaneously displayed. Herein, the identification of the vehicle 200 may be a vehicle number, the identification of the second terminal 400 may be a phone number, and the vehicle number of the adjacent vehicle 200 or the phone number of the second terminal 400 may be displayed in a way that a part of the vehicle number, or a part of the phone number is omitted. Meanwhile, according to embodiments, identification information of the adjacent vehicle 200 or the second terminal 400 may include nickname information. The nickname information may be a nickname which is pre-set by a user of the adjacent vehicle 200 or the second terminal 400, or a nickname, which is pre-set based on a manufacturer, device type, or device color.

FIG. 14B is a view illustrating an example of a screen in which an identification of the adjacent vehicle 200 or the second terminal 400 may be displayed in a list type. Referring to FIG. 14B, the identification of the adjacent vehicle 200 or the second terminal 400 may be displayed in a list type. According to embodiments, the identification of the adjacent vehicle 200 or the second terminal 400 may be displayed side by side, only identification of the adjacent vehicle 200 may be displayed, or only identification of the second terminal 400 may be displayed

FIG. 14C is a view illustrating an example of a screen in which an identification of the adjacent vehicle 200, which is grouped based on a certain reference, may be displayed as a nickname. Referring to FIG. 14C, on the display unit of the first terminal 300, a range of a local area network formed with the host vehicle 100 as the center may be displayed, and identification information of the adjacent vehicle 200, which is grouped based on a certain reference, among the identification of the adjacent vehicle 200 included in the range of the local area network, may be displayed.

FIG. 14C is a view of an example in which the adjacent vehicle is grouped based on a manufacturer. In FIG. 14, identification information, which is subject to grouping, may be displayed in dark, and identification information, which is excluded from grouping, may be displayed in blur. Meanwhile, the display method of identification information is not limited thereto, and thus identification information may be displayed in various methods.

FIG. 14D is a view of an example of a screen in which a grouping list of the adjacent vehicle is displayed. Referring to FIG. 14D, on the display unit of the first terminal 300, a grouping list of the adjacent vehicle 200, which is grouped based on a pre-set reference, may be displayed. For example, the adjacent vehicle 200 may be grouped based on a certain reference, such as the vehicle color, the vehicle type, and a manufacturer, and the grouping list may be displayed on the display unit of the first terminal 300.

Hereinafter a process of forming a chat room will be described with reference to a screen illustrated in FIG. 14A.

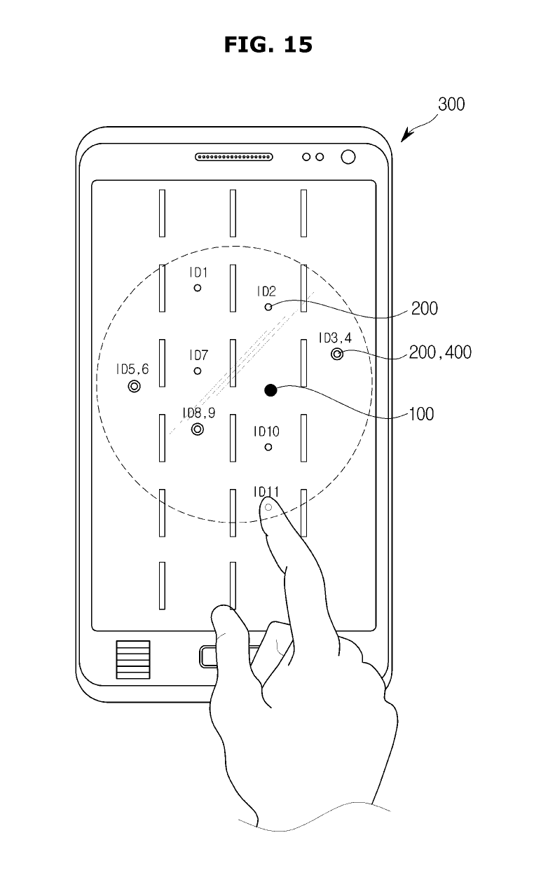

FIG. 15 is a view illustrating an example in which a user invites the adjacent vehicle 200 or the second terminal 400 included in a local area network. As illustrated in FIG. 15, the user may invite the adjacent vehicle 200 or the second terminal 400 by touching the adjacent vehicle 200 or the second terminal 400 via a touch screen of the first terminal 300. Alternatively, a push button may be employed according to the type of the first terminal 300, and then the adjacent vehicle 200 or the second terminal 400 may be invited.

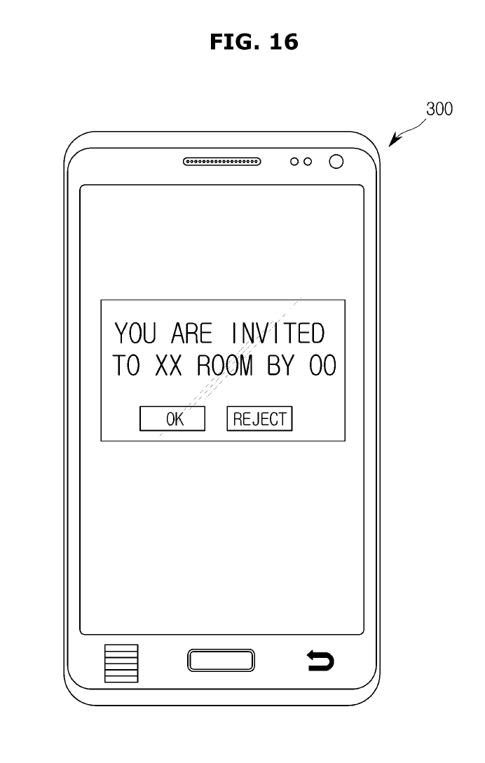

FIG. 16 is a view of an example of a screen displayed on the second display unit 220 of the adjacent vehicle 200 or the display unit of the second terminal 400, when a user sends an invitation message to a user of the adjacent vehicle 200 or the second terminal 400 as illustrated in FIG. 15. When the user sends an invitation message to a user of the adjacent vehicle 200 or the second terminal 400, a chat window indicating the invitation to a chat room may be formed in the adjacent vehicle 200 or the second terminal 400, as illustrated in FIG. 16.

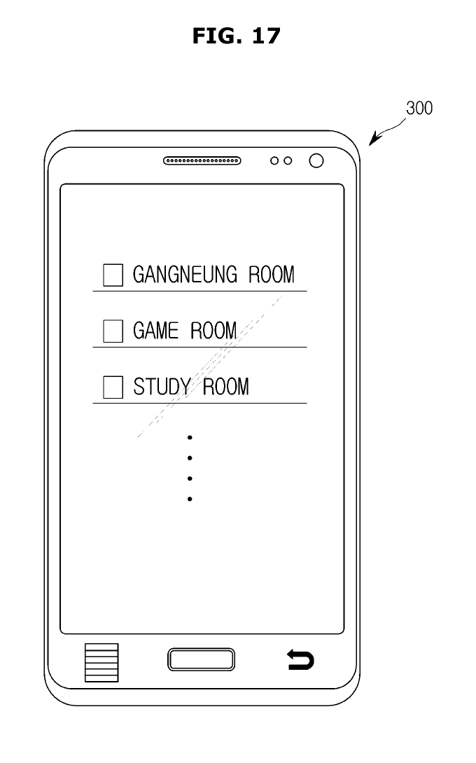

FIG. 17 is a view illustrating an example of forming a chat room in accordance with another embodiment of the present disclosure.

Each of the vehicles on a road may be a pre-host vehicle, and thus may form a chat room by becoming a host vehicle. In this case, a list of chat rooms may be displayed on the second display unit 220 of the adjacent vehicle 100 included in the range of the local area network of the host vehicle 100, as illustrated in FIG. 17. For example, a list such as a game room, and a study room may be displayed. A host of each chat room may be different from each other, or may be the same in some cases.

Next, an operation in which the host vehicle 100 and the adjacent vehicle 200 share information may be performed 630. According to embodiments, the shared information may include common interests of the host vehicle 100 and the adjacent vehicle 200, more particularly, education, game, Social Networking Service (SNS), road conditions, sights, restaurants or destination information.

An operation of sharing information with the adjacent vehicle 200 may include sharing information with the adjacent vehicle 200 in response to a request of the host vehicle 100, sharing information with the adjacent vehicle 200 via a vehicle in response to a request of the host vehicle 100, sharing information with the adjacent vehicle 200 via a server of the base station 500, and sharing information with the adjacent vehicle 200 by using a method, which is a combination of aforementioned methods.

Particularly, sharing information with the adjacent vehicle 200 via the host vehicle 100 in response to a request of the first terminal 300 connected to the host vehicle 100 may include sharing information with the adjacent vehicle 200 via the host vehicle 100 in response to an application stored in the first terminal 300. According to one embodiment, a user may execute a certain application installed in the first terminal 300 to share information with the adjacent vehicle 200. The application may be a self-development application for the present disclosure, and particularly the application may provide an authentication service to the adjacent vehicle 200, and an application adapting service with another application. Therefore, a user of the host vehicle 100 may share information with the adjacent vehicle 200 based on the application.

According to embodiments, a case in which the adjacent vehicle 200 has escaped from a range of local area network formed by the host vehicle 100 may occur. In this case, when the host vehicle 100 intends to keep sharing information with the adjacent vehicle 200, information may be shared via the base station 500, and when the host vehicle 100 intends to stop sharing information with the adjacent vehicle 200, D2D communication between the host vehicle 100 and the adjacent vehicle 200 may be blocked.

Meanwhile, the host vehicle 100 and the adjacent vehicle 200 may exchange information via the base station 500. A case in which the host vehicle 100 is away from the adjacent vehicle 200 during a process of exchanging information via the base station 500, may occur. In this case, when the host vehicle 100 intends to keep sharing information with the adjacent vehicle 200, information may be shared via the base station 500, and when the host vehicle 100 intends to stop sharing information with the adjacent vehicle 200, a communication between the host vehicle 100 and the adjacent vehicle 200 via the base station 500 may be blocked.

After performing an operation of sharing information with the adjacent vehicle 200, an operation of displaying shared information may be performed 640.

Shared information may be displayed on the first terminal 300 carried by a passenger of the vehicle 100, or may be displayed on the display unit of the second terminal 400 carried by a passenger of the adjacent vehicle 200, and according to embodiments, a screen of the first terminal 300 and a screen of the second terminal 400 may be displayed on the first display unit 120 or the second display unit 220, respectively, in a mirroring manner. Hereinafter a description the same as those described above will be omitted.

Meanwhile, a control method of a vehicle may further include an operation of forming a separate local area network in the vehicle.

Particularly, a communication in the vehicle 100 may be performed in a way that a vehicle modem becomes a host, by using a communication method, such as 3G, 4G, 5G and/or Wi-Fi. Herein, the communication in the vehicle 100 may include a communication between the first terminals 300, which are carried by passengers in the vehicle 100, or a communication between the first terminal 300 and the vehicle 100. In other words, a communication method according to embodiments may be useful when a number of passengers enter the vehicle 100.

The control method of the vehicle 100 and 100a is described above.

As is apparent from the above description, according to the proposed vehicle and the control method of the vehicle, a service of generating and sharing information, which is of interest to people, may be provided by forming a local area network with people who are under the same conditions while driving.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A vehicle comprising:
a communication unit for forming a local area network with adjacent vehicles, wherein the vehicle is the center and configured to share information with the adjacent vehicles via the vehicle in response to a request of a terminal connected to the vehicle; and
a display unit for displaying the shared information.

2. The vehicle of claim 1 wherein, the communication unit shares information with the adjacent vehicles via the vehicle in response to a request of an application stored in the terminal.

3. The vehicle of claim 2 wherein, the application provides an authentication service for the adjacent vehicles.

4. The vehicle of claim 2 wherein, the application provides an adapting service with other application.

5. The vehicle of claim 1 wherein the display unit displays a list of the adjacent vehicles and the terminal, both of which are included in a range of the local area network.

6. The vehicle of claim 5 wherein the display unit displays of a grouping list, which is a list of a grouped adjacent vehicle and a grouped terminal, both of which are grouped based on a pre-set reference.

7. The vehicle of claim 1 wherein the terminal is connected to the vehicle through a wired or a wireless communication.

8. The vehicle of claim 1 wherein the communication unit shares information with the adjacent vehicles via a server.

9. The vehicle of claim 8 wherein the communication unit shares information with the adjacent vehicles via the server when the adjacent vehicle has escaped from the local area network.

10. The vehicle of claim 1 wherein the communication unit forms a separate local area network in the vehicle.

11. The vehicle of claim 1 wherein the shared information comprises at least one common interest of the vehicle and the adjacent vehicle, wherein the at least one common interest is selected from the group consisting of education, games, Social Networking Service (SNS), road conditions, sights, restaurants and destination information.

12. A vehicle comprising:
a communication unit for forming a local area network with adjacent vehicles via a server and sharing information with the adjacent vehicles;
a display unit for displaying the shared information; and
a controller for controlling the communication unit to maintain or block a connection with the adjacent vehicles when the adjacent vehicles have escaped from the local area network.

13. A control method of a vehicle comprising:
forming a local area network with adjacent vehicles, wherein the vehicle is the center;
sharing information with the adjacent vehicles via the vehicle in response to a request of a terminal connected to the vehicle; and
displaying the shared information.

14. The control method of claim 13 wherein the step of sharing information with the adjacent vehicles comprises sharing information with the adjacent vehicles via the vehicle in response to a request of an application stored in the terminal.

15. The control method of claim 13 wherein the step of sharing information with the adjacent vehicles comprises sharing information with the adjacent vehicles via a server.

16. The control method of claim 15 wherein the step of sharing information with the adjacent vehicles comprises sharing information with the adjacent vehicles via a server when the adjacent vehicles have escaped from the local area network.

17. The control method of claim 13 further comprising forming a separate local area network in the vehicle.

18. The control method of claim 13 further comprising displaying a list of the adjacent vehicles and the terminal, both of which are present in a range of the local area network.

19. The control method of claim 18 wherein the step of displaying a list of the adjacent vehicles and the terminal, both of which are present in a range of the local area network, comprises displaying a list of grouped adjacent vehicles and a grouped terminal, both of which are grouped based on a pre-set reference.
